(19) United States
(12) Patent Application Publication
(10) Pub. No.: US 2007/0095058 A1
(43) Pub. Date: May 3, 2007

(54) Hydraulic power unit and springs (coil) combined into a metal hydraulic oil tank to become an energy power unit

(76) Inventor: Thomas Gesuale, Northport, NY (US)

Correspondence Address: THOMAS GESUALE, 11 LADY JANE'S WAY, NORTHPORT, NY, 11768, US

(21) Appl. No.: 11/213,298

(22) Filed: Nov. 2, 2005

(51) Int. Cl. F16D 31/02

(52) U.S. Cl. 60/413

(57) ABSTRACT

This apparatus has the ability to transport energy to propel a generator. This invention uses coil springs as a way to store energy. A hydraulic pump is used to force hydraulic oil into a hydraulic tank with up to 3,500 pounds of pressure per square inch. The hydraulic oil with the help of a hydraulic jack will collapse the springs. Once the springs are fully collapsed the pump will stop working, allowing the springs to uncoil or come back to full size. While returning to their uncoiled position the springs will push and propel oil out of the bottom end of the hydraulic tank and into a hydraulic motor. The hydraulic motor will be connected to a generator to produce electricity. Two or more power units will be used together, one unit will be recharging while the other is working to operate the generator. A small power unit and generator can be used in family's house relieving the homeowner of fuel costs. The same unit placed in the house can also charge a battery to run the family car. This invention not only helps relieve our dependence of fossil fuels but does so in a completely pollution free manner, eliminating both air and noise pollution.

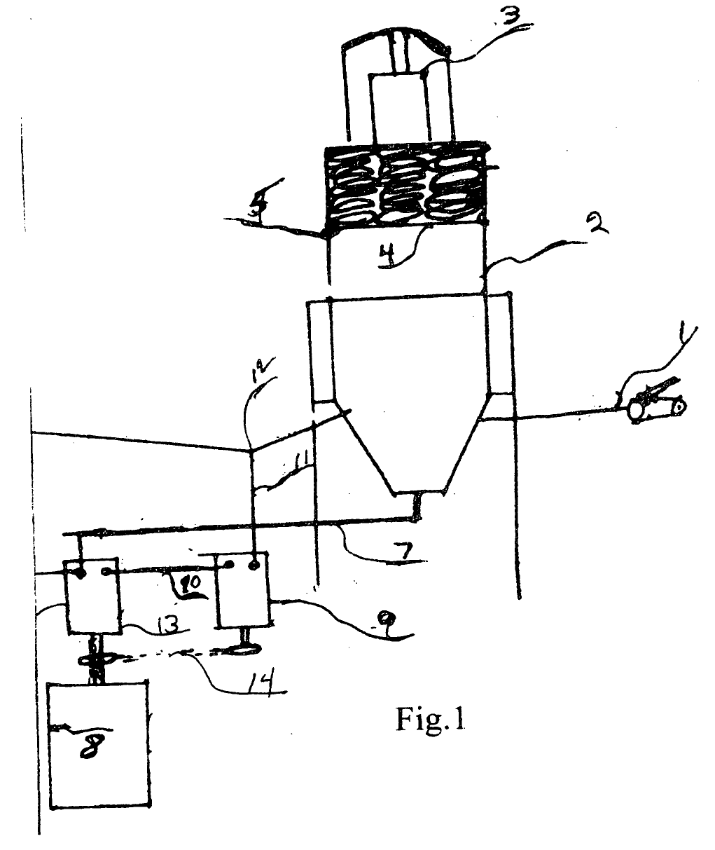

### DESCRIPTION OF DRAWING—SHEET 1. FIG. 1

Hydraulic Hand Pump: used to fill hydraulic tank #1. (1)

Hydraulic Tank #1: Used to contain hydraulic oil from the hand (2) pump to collapse the coil springs.

Hydraulic Jack Mounted on top of Hydraulic tank: used to (3) Collapse coil springs.

Lifting plate: attached to piston that collapses coil springs. (4)

Seals: Preventing oil from hydraulic tank going into spring chamber. (5)

Hydraulic Oil Line: connected to bottom of tank used to charge hydraulic motor. (7)

Generator Motor: propelled by hydraulic motor to produce Electricity. (8)

Hydraulic Oil Pump: driven by belt and or the electricity produced from the from generator. (9)

Hydraulic Line: exiting hydraulic motor entering hydraulic pump (10)

Lines exiting hydraulic pump: used to recharge hydraulic tanks #1 and tank #2 when ready (11)

T—Valve: used to direct oil from tank #1 and tank.#2 (12)

Hydraulic Motor: used to drive generator and supply hydraulic oil to hydraulic oil pump which recharges tank #1 and #2 (13)

Belt: used to drive pump (14)

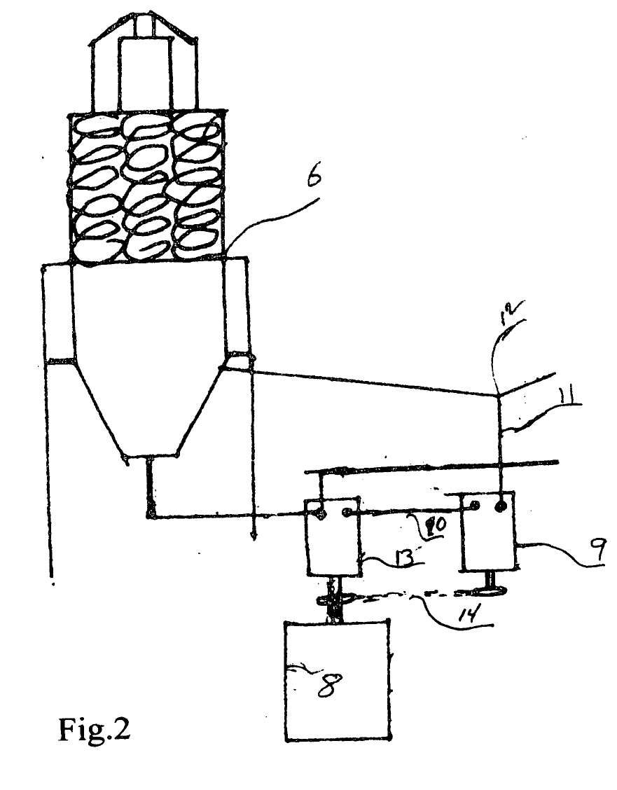

### Description of Drawing—Sheet 2, FIG. 2

Hydraulic Tank #2: preparing to accept hydraulic oil from oil pump to collapse coil springs (6)

Generator Motor: propelled by hydraulic motor to produce Electricity. (8)

Hydraulic Oil Pump: driven by belt and or the electricity produced from the from generator. (9)

Hydraulic Line: exiting hydraulic motor entering hydraulic pump (10)

Lines exiting hydraulic pump: used to recharge hydraulic tanks #1 and tank #2 when ready ( 11)

T—Valve: used to direct oil from tank #1 and tank #2 (12)

Hydraulic Motor: used to drive generator and supply hydraulic oil to hydraulic oil pump which recharges tank #1 and #2 (13)

Belt: used to drive pump (14)

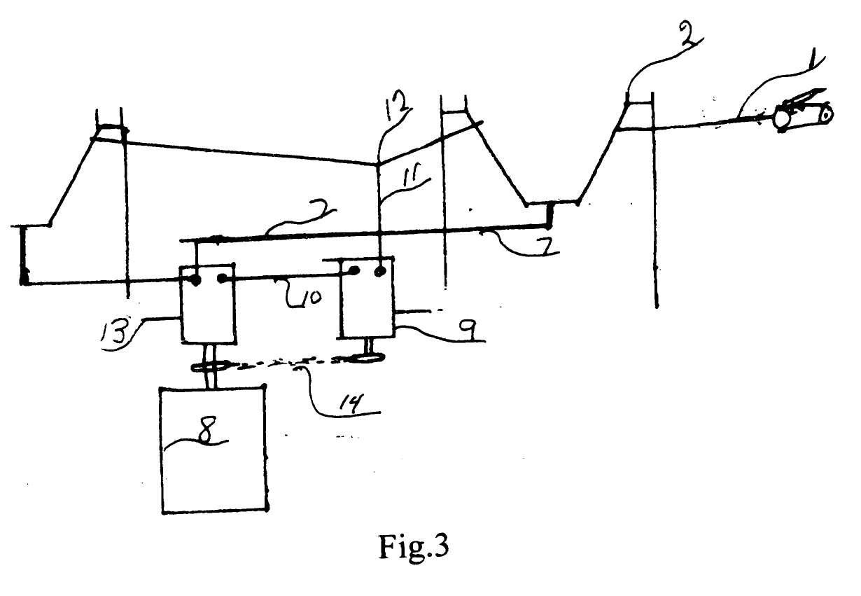

### Description of Drawing—Sheet 3, FIG. 3

Hydraulic Hand Pump: used to fill hydraulic tank #1 (1)

Hydraulic Tank #1: Used to contain hydraulic oil from the hand (2) pump to collapse the coil springs

Hydraulic Oil Line: connected to bottom of tank used to charge (7) hydraulic motor

Generator Motor: propelled by hydraulic motor to produce Electricity. (8)

Hydraulic Oil Pump: driven by belt and or the electricity produced from the from generator. (9)

Hydraulic Line: exiting hydraulic motor entering hydraulic pump (10)

Lines exiting hydraulic pump: used to recharge hydraulic tanks #1 and tank #2 when ready (11)

T—Valve: used to direct oil from tank #1 and tank #2 (12)

Hydraulic Motor: used to drive generator and supply hydraulic oil to hydraulic oil pump which recharges tank #1 and #2 (13)

Belt: used to drive pump (14)

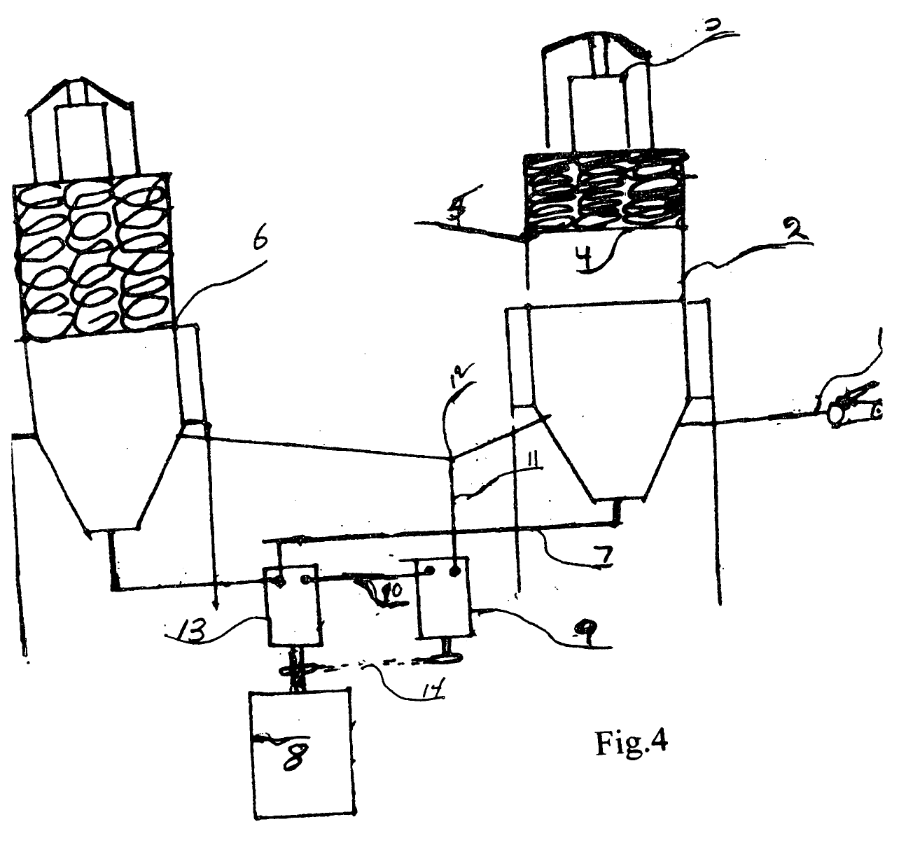

### Description of Drawing—Sheet 4, FIG. 4

Hydraulic Hand Pump: used to fill hydraulic tank #1. (1)

Hydraulic Tank #1: Used to contain hydraulic oil from the hand (2) pump to collapse the coil springs.

Hydraulic Jack Mounted on top of Hydraulic tank: used to (3) Collapse coil springs.

Lifting plate: attached to piston that collapses coil springs. (4)

Seals: Preventing oil from hydraulic tank going into spring chamber. (5)

Hydraulic Tank #2: preparing to accept hydraulic oil from oil pump to collapse coil springs. (6)

Hydraulic Oil Line: connected to bottom of tank used to charge hydraulic motor. (7)

Generator Motor: propelled by hydraulic motor to produce Electricity. (8)

Hydraulic Oil Pump: driven by belt and or the electricity produced from the from generator. (9)

Hydraulic Line: exiting hydraulic motor entering hydraulic pump (10)

Lines exiting hydraulic pump: used to recharge hydraulic tanks #1 and tank #2 when ready (11)

T—Valve: used to direct oil from tank #1 and tank #2 (12)

Hydraulic Motor: used to drive generator and supply hydraulic oil to hydraulic oil pump which recharges tank #1 and #2 (13)

Belt: used to drive pump (14)

1. This apparatus has the ability to use hydraulic oil power and coil springs inside a hydraulic tank to become an energy power unit. The coil springs will be collapsed using a hydraulic hand pump. Once the coil springs have been collapsed they will be allowed to uncoil and return to their normal size. The pressure released from the springs will push oil out of the tank unit and into a hydraulic motor. The hydraulic motor will be attached to a generator to produce electricity.

2. This system is designed to use two or more of the hydraulic tanks as described above. As the first hydraulic tank unit powers the generator the electricity produced from the generator will be used run a hydraulic pump that will recharge the second hydraulic tank and also run a generator.

3. By using a 1-ton hydraulic jack with a hand pump I can lift 1 ton (2,000 lbs.) using 1 to 5 lbs. of hand pressure. A hydraulic tank that contains eight coiled springs will take 1 to 5 pounds of hand pressure to fully collapse the springs inside the tank. Once the coiled springs are collapsed they will contain up to 2,000 lbs. of pressure. Once the coiled springs are released, allowing them to uncoil and return to their normal size, hydraulic oil inside the tank will be pushed into a hydraulic motor at a rate of up to 2,000 psi. Therefore, 1 lb. of hand pressure will produce up to 2000 lbs of hydraulic pressure. Giving the equivalent of a 2000 to 1 ratio.
